(19) United States
(12) Patent Application Publication
(10) Pub. No.: US 2018/0259370 A1
(43) Pub. Date: Sep. 13, 2018

(54) Multimode Fiber Sensor and Sensing Using Forward and Backward Scattering

(71) Applicants: Nicolas K. FONTAINE, Keyport, NJ (US); Peter J. WINZER, Aberdeen, NJ (US); Haoshuo CHEN, Aberdeen, NJ (US); Roland RYF, Aberdeen, NJ (US); David T. NEILSON, Old Bridge, NJ (US)

(72) Inventors: Nicolas K. FONTAINE, Keyport, NJ (US); Peter J. WINZER, Aberdeen, NJ (US); Haoshuo CHEN, Aberdeen, NJ (US); Roland RYF, Aberdeen, NJ (US); David T. NEILSON, Old Bridge, NJ (US)

(21) Appl. No.: 15/453,688

(22) Filed: Mar. 8, 2017

(51) Int. Cl. G01D 5/353

(52) U.S. Cl. CPC G01D 5/3539

(57) ABSTRACT

An apparatus, including: an optical sensor fiber having a first end optically couplable to receive light from a light source, wherein the optical sensor fiber is a multimode optical fiber configured to carry light in different spatial propagating modes, wherein the optical sensor fiber is constructed such that environmental fluctuations couple light energy between some of the spatial propagating modes; a spatial propagating mode demultiplexer optically coupled to a second end the optical sensor fiber and configured to separate a plurality of light signals received from different ones of the spatial propagating modes; and an optical receiver configured to process the separated light signals and to estimate a longitudinal position of one of the environmental fluctuations along the optical sensor fiber based a measured delay between arrival times of the separated light signals.

### BACKGROUND

The subject matter discussed herein relates generally to multimode optical fiber sensors and sensing using forward and/or backward scattering.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of an exemplary embodiment adequate to allow those of ordinary skill in the art to make and use the inventive concepts will follow in later sections.

Various exemplary embodiments relate to an apparatus, including: an optical sensor fiber having a first end optically couplable to receive light from a light source, wherein the optical sensor fiber is a multimode optical fiber configured to carry light in different spatial propagating modes, wherein the optical sensor fiber is constructed such that environmental fluctuations couple light energy between some of the spatial propagating modes; a spatial propagating mode demultiplexer optically coupled to a second end the optical sensor fiber and configured to separate a plurality of light signals received from different ones of the spatial propagating modes; and an optical receiver configured to process the separated light signals and to estimate a longitudinal position of one of the environmental fluctuations along the optical sensor fiber based a measured delay between arrival times of the separated light signals.

Further, various exemplary embodiments relate to an optical splitter configured to split a light signal from the light source into a plurality of light signals and optically couple said light signals to different ones of the spatial propagating modes at the first end.

Further, various exemplary embodiments relate to an optical delivery fiber core configured to couple the light signal from the light source to the optical splitter, the optical delivery fiber being near to and substantially parallel to an optical core of the optical sensor fiber.

Further, various exemplary embodiments relate to a second spatial propagating mode demultiplexer configured to couple the optical splitter to the optical sensor fiber.

Further, various exemplary embodiments relate to a wherein optical splitter is configured to relatively delay the split light signals from one another.

Further, various exemplary embodiments are described wherein the optical receivers calculate another characteristic of the one of the environmental fluctuations based upon a measurement of a spatial propagating mode coupling of the optical sensor fiber.

Further, various exemplary embodiments are described wherein the position is calculated based upon the difference in group velocities of some of the spatial propagating modes of the optical sensor fiber.

Further, various exemplary embodiments are described wherein a difference in group velocities of some of the spatial propagating modes of the optical sensor fiber are large enough to temporally separate some of the light signals received from different ones of the spatial propagating modes at the second end.

Further, various exemplary embodiments relate to an optical coupler coupled between the light source and the sensor fiber and between the sensor fiber and the spatial propagating mode demultiplexer, wherein the optical sensor fiber is a composite optical sensor fiber including a multimode fiber sensing core and a delivery fiber core and the optical coupler is configured to optically couple light from the light source into the delivery fiber core and to couple light from the sensor fiber core to the a spatial propagating mode demultiplexer.

Further various exemplary embodiments relate to a method, including: coupling a light signal from a light source into a first end of optical sensor fiber, wherein the optical sensor fiber is a multimode fiber configured to carry light in different spatial propagating modes and wherein the optical sensor fiber is constructed such that nearby environmental fluctuations can couple light energy between some of the spatial propagating modes; in an optical spatial propagating mode demultiplexer, separating light signals from different ones of the spatial propagating modes of the optical sensor fiber at a second end the optical sensor fiber; and processing the separated light signals in optical receivers to determine a position of one of the environmental fluctuations along the optical sensor fiber based measurements of relative delays between the light signals.

Further, various exemplary embodiments relate to an optical splitter, splitting a light signal from a light source into a plurality of light signals; and coupling the light signals from the light source into different ones of the spatial propagating modes at the first end of the optical sensor fiber.

Further, various exemplary embodiments relate to coupling the light signal from the light source to the optical splitter by a delivery fiber core, wherein the delivery fiber core is substantially alongside the optical sensor fiber.

Further, various exemplary embodiments relate to optically coupling the optical splitter to the optical sensor fiber by an optical spatial propagating mode demultiplexer.

Further, various exemplary embodiments relate to delaying the split light signals from one another by the optical splitter.

Further, various exemplary embodiments are described wherein the optical receivers is configured evaluate another characteristic of the one of the environmental fluctuations based upon a spatial propagating mode coupling in the sensor fiber.

Further, various exemplary embodiments are described wherein the position is calculated based upon the difference in group velocities of some of the spatial propagating modes.

Further, various exemplary embodiments are described wherein the difference in group velocities are large enough to separate, at the second end, the light signals received from the different modes in time.

### BRIEF DESCRIPTION OF THE DRAWINGS

In order to better understand various exemplary embodiments, reference is made to the accompanying drawings, wherein:

FIG. 1 illustrates an embodiment of a multimode optical fiber sensor;

FIG. 2 illustrates an embodiment of an optical reflector that may be used in the multimode optical fiber sensor of FIG. 1;

FIG. 3 illustrates another embodiment of a multimode optical fiber sensor;

FIG. 4A shows an embodiment of a composite sensing fiber that may be used in the embodiment of FIG. 3;

FIG. 4B shows an embodiment of a reflector that may be used in the embodiment of FIGS. 3; and

FIG. 5 illustrates another embodiment of the of a multimode fiber sensor using only backscattering.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

The subject matter described herein may be used for sensing and/or monitoring in various situations and may be used to measure, in a location dependent manner, longitudinal stress, transverse strains, temperature, pressure, electromagnetic fields, the presence of a specific chemical, acoustic waves, etc.

Herein, unless otherwise stated or specifically indicated, the term “mode” refers to a spatial propagating mode of a multimode optical fiber, and different ones of said spatial propagating modes have different lateral intensity profiles and/or different lateral phase profiles in the multimode optical fiber.

Optical fiber sensors may use a single-mode optical fiber and use time-resolved backscattering to identify the location of events. At scattering events, light scatters into either or both the forward and backward propagating modes of the fiber. But, it may not be feasible to use the forward direction for depth sensing, in a single mode fiber, because the distance of the scattering event from the end of the optical fiber will not typically effect the delay for the light to propagate along the entire length of the optical fiber. That is, scattering events at different locations along the optical fiber would typically produce temporally overlapping scattered light signals in the forward propagation direction.

Backward scattering can be used for determining the longitudinal location of a scattering event, in a sensing optical fiber, because the a distance (z) along the sensing optical fiber where a local scattering event occurs determines a unique time delay for back scattered light to be received at the initial end of the sensing optical fiber. For back scattering, the round trip, time delay to receive scattered light is given by t=2 z/vₙ, where z is the distance along the fiber where the scattering event occurs and vₙ is the group velocity of the light in the optical fiber. As result, by measuring the time between the transmission of a light pulse and the receipt of its reflection, the distance of the scattering structure from the end of the optical fiber may be determined. Because the backscatter light, which is created by an event to be sensed/measured, is often small, sensing based on optical backscattering is susceptible to noise and may not be as accurate as desired.

As there may be more scattered optical power available in the forward scattering direction than in the backward scattering direction, exploiting optical forward scattering, for distance resolved optical sensing, may increase the sensor's signal to noise ratio (SNR).

In some embodiments, multiple optical propagating modes of a sensing multimode optical fiber are used to obtain remote sensing information from forward scattered light. In some such embodiments, a delivery fiber delivers light to the sensor fiber's distal end and said light is transmitted backwards in the multimode optical sensing fiber. Since some propagating modes of a multimode optical sensing fiber may travel at different speeds within the optical sensing fiber can provide information about the longitudinal location of a scatterer from relative delays between light of different modes when forward scattered.

Various scattering events can cause the coupling of different propagating modes of an optical fiber. Because different propagating modes may travel at different speeds (i.e., a mode has a propagation speed vₘ), the location of such a scattering event along the length of the optical fiber may affect the relative arrival time delay, for light scattered to different propagating modes by a such a localized scattering event. For this reason, the location of a localized scattering event in a multimode optical sensing fiber may be determined from measurements of the forward scattering of a light pulse therein.

If a multimode sensor fiber has a high differential modal group delay, then more accurate location measurements may be possible. This contrasts with the desired properties of multimode and multi-core optical fibers fabricated for optical communications, where small differential group delays are usually preferred.

For arrival at the opposite end of the optical sensing fiber the relative pulse arrival delay Dₜ when light is initially transmitted into propagating model, a first end of the optical sensing fiber and is scattered into propagating modes 1 and 2, a light that is:

Dₜ=(L−z)(1/v₂−1/v₁).

Here, L is the total length of the fiber, v₁ is the group velocity of a first mode originally coupled into the optical sensing fiber, v₂ is the group velocity of a second mode, whose light is generated light of the from the first mode, by the scattering event, at a distance z from a first end of the optical fiber. Accordingly, when light is received at the second end of the multimode optical sensing fiber, the received light signal may be separated into its separate modes, and the relative pulse delay determined. Then the distance of the scattering event associated with the light received in that second mode may be determined based upon the equation for Dₜ. Further processing of the received light may further provide a measurement of physical parameter(s) related to the scattering event, such as stress, strain, temperature, pressure, electromagnetic fields, the presence of a specific chemical, acoustic waves, etc. For example, Raman and Brillouin scattering in the optical fiber may be affected by temperature and pressure of the fiber. As a result variations in scattering, e.g. power variations in scattered signals, may be measured and the temperature or pressure calculated. Also, FBGs may be used in a similar manner as the specific wavelengths of light that are reflected and propagated may vary due to temperature and pressure.

In some embodiments, in addition to using two modes to sense local scattering events, light signals may be launched into more modes, and the response to the scattering event may be measured in more than one optical mode. The use of more launch modes may allow for better estimation of the distance of specific local scattering events, e.g., provide more accurate distance measurements. If the entire mode transfer matrix is measured (i.e., every input mode to every output mode) more types of sensing measurements may be made because different mode couplings may be more effected by different types of local scattering events, e.g., events related strain, stress, temperature, fluctuations, etc. When multiple launch and/or received modes are used and observed, it may be beneficial to apply relative delays between pulse on different ones of the modes as launch into the multimode optical sensing fiber to allow for the time resolution of the observation of received light signals on different modes.

In various embodiments, the optical sensing fiber may be designed to have modes guided by multiple optical cores, or by a single optical core. Localized scatterers such as fiber Bragg gratings, microbends, or any other fiber feature may be also added at specific locations along the optical sensing fiber to enhance the mode-to-mode coupling in order to provide enhanced sensing locations. These localized scatters may allow for sensing using either forward scattering or backscattering of light.

Embodiments are described herein for the use of optical forward scattering to sense distance to a localized scatterer and various parameters related to the localized scatterer, wherein the localized scatter is produced by local variations optical sensing fiber's environment.

By designing and selecting the optical sensing fiber's modal properties, such as phase velocity difference of each mode, differential group delay of each mode, number of modes, degeneracy, and spatial or angular symmetry of the modes, etc., as well as the properties of any intentionally added localized mode scatterers, the mode coupling may be designed to be different for different physical effects (e.g., longitudinal strain or transversal stress). For measurements, this use of multiple propagating modes can enable the independent measurement of various local sensing parameters. For example, an optical sensing fiber may have circular optical core or an optical core of non-axially symmetric shape, e.g., an elliptical optical core. In embodiments, where the optical sensing fiber has a non-circular symmetric optical core (for example an elliptical optical core), the degeneracy between spatially different propagating modes may be removed, and the coupling of different modes, which is induced by stress (or bending) in the two orthogonal transversal directions, may be distinguishable, in the resulting coupling between different propagating modes. Each localized physical environmental fluctuation has its own signature, in the resulting mode coupling pattern, which will allow for light forward scattering measurements distinguishing one type of local environmental fluctuation from others for optical sensing fibers having selected modal properties (phase velocity difference, differential group delay, number of modes, degeneracy, and symmetry, etc.) to measure properties of the desired environmental fluctuations.

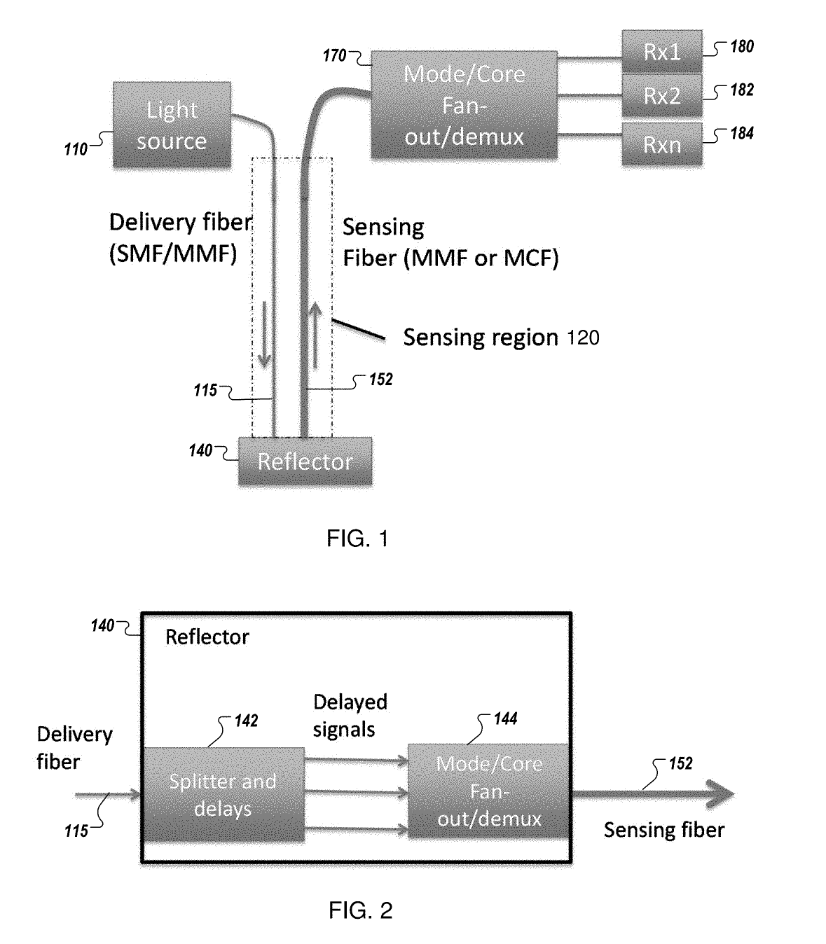

FIG. 1 illustrates an embodiment of a multimode fiber sensor. This embodiment may include a light source 110 that provides light signals via a delivery fiber 115 to a reflector 140. The light source may be a continuous wave (CW) or pulsed laser, e.g., a mode locked laser, a source of an optical frequency comb, etc. The delivery fiber 115 may be a single-mode fiber (SMF) or a multimode fiber (MMF). The reflector 140, shown in an expanded form in FIG. 2, couples received light from the delivery fiber 115 into an optical sensing fiber 152 in a backwards direction. The optical sensing fiber 152 may include various scattering features at various locations to provide for enhanced sensitivity to various localized fluctuations at those locations. The sensing fiber 152 may be multimode optical fiber (MMF) or a multicore optical fiber (MCF). In some embodiments, light is delivered by light source 110 through either the fundamental mode of a MMF, through an additional single mode core, or through a single-mode delivery fiber, and is then split by the reflector 140 and coupled backwards into one or more modes/optical cores of the optical sensing fiber.

The optical sensing fiber is also connected to a modecore fanoutdemux (MCFD) 170 that directs the light of different propagating modes, as received from the optical sensing fiber 152, to different optical outputs. The different optical outputs of the MCFD 170 are optically coupled to or connected to corresponding receivers 180-184. At the optical receivers 180-184, the intensity and/or phase of the light of the various modes may be detected, e.g., coherently by mixing with mutually coherent light of the transmit laser source in conventional optical hybrids and subsequent detection in balanced phot-diode pairs, or incoherently in photo-diodes. The optical receivers 180-184 may instead be integrated into a single optical receiver with various ports for processing the received light signals from the corresponding different propagation modes of the optical sensing fiber.

Localized environmental fluctuations, e.g., in temperature, pressure or lateral stress(es) induce localized mode coupling within the optical sensing fiber so that one or more optical signals are generated in propagating mode(s) that differ from the launch propagating mode. Such localized mode coupling may be measured via the optical receivers Rx1-Rxn 180-184 and used to calculate the longitudinal position of the respective coupling event and thus, the environmental fluctuation along the length of the optical sensing fiber 152. The area shown with a dotted box or some longitudinal segment thereof may be considered as a sensing region 120 for such fluctuations. For example, sensing as described in this embodiment may be done in at least part of the sensing region 120 using optical forward scattering.

Multimode fibers (MMF) and multicore fibers (MCF) may be designed to have cores with enhanced sensitivity to specific types of environmental fluctuations to sense more environmental parameters in a single optical sensing fiber Further, the impulse response information can be compressed in time by using shorter pulses which enables more rapid measurements and averaging over the desired length scales

Different physical effects like strain, temperature, or unidirectional pressure have a different impact on mode coupling. For example if lateral pressure is applied, the change in coupling will affect the degenerate modes like the LP11a and LP11b in different ways, whereas, temperature and strain will typically cause similar coupling effects for both LP11a and L11b modes.

The differentiation between temperature and strain may be achieved by looking at the difference in coupling between modes: for temperature the effect is dominated by the fact that the fiber core and cladding material have typically slightly different thermo-optic coefficients, whereas for strain a pure mechanical deformation will create a pure geometric driven change and should have a different mode-coupling signature than temperature.

Sensing as described above uses the different propagation speeds of the different propagating modes in a multimode optical fiber, e.g., to determine the longitudinal location of an environmental fluctuation of interest. Such determinations are based on the characterization of the locations of localized scattering events through measurements of relative mode delays as already described. For example, if a specific mode is coupled, by a localized environmental fluctuation, to two other modes, wherein each mode is separately detectable and has a different group velocity, then the measured difference in the arrival times of light of these modes at the optical receivers Rx1-Rxn provides a direct measurement of the location of the localized environmental fluctuation along the length of the optical sensing fiber 152.

The sensing system is based on spatial division multiplexing (SDM) using multimode optical fibers or optical SDM. Accordingly, the sensors and sensing embodiments, as described herein, may be used, for example, in oil and gas exploration, such as sensing and/or monitoring an oil field, a gas field, and in-ground storage of oil, gas, or other liquids. These embodiments may also be used in other harsh environments as well as in remote and distributed environments.

FIG. 2 illustrates an embodiment of a reflector that may be used in the multimode optical fiber sensor of FIG. 1. Reflector 140 may include an optical splitter and optical delays 142 to split light signals from delivery fiber 115 into one or more channels of relatively delayed optical signals. Each channel of the delayed signal may have a different delay. Such delays may be used when multiple modes are input to the multimode fiber, e.g., to help to distinguish the different input mode signals from one another in time when received by the optical receivers Rx1-Rxn. The delayed optical signals are fed into the different modes or optical cores of the sensing fiber 152 by the MCFD 144.

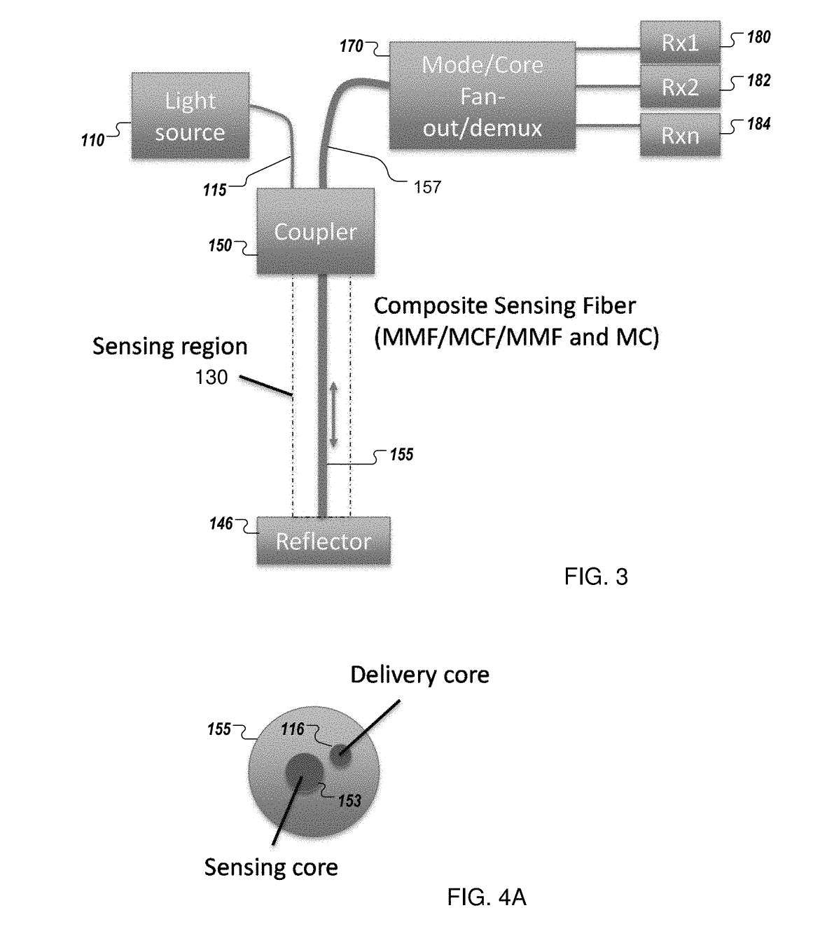

FIG. 3 illustrates another embodiment of a multimode optical fiber sensor. This embodiment differs from the example implementation shown in FIG. 1 in having an optical coupler 150, a composite optical sensing fiber 155, and a different type of optical reflector 146. The optical coupler 150 couples light signals from the delivery fiber 115 to the composite optical sensing fiber 155. The optical coupler 150 also couples light signals from the composite optical sensing fiber 155 to the multimode optical fiber 157, which is also optically connected to the MCFD 170. The MCFD 170 operates as described above and is connected to optical receivers 180-184 as described above.

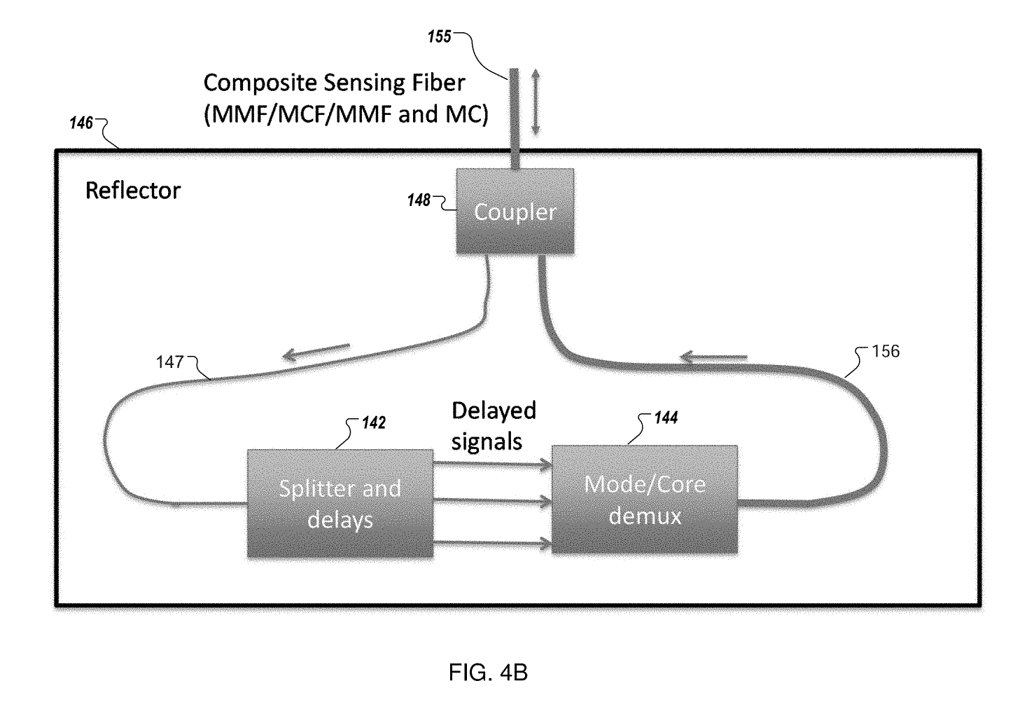

FIG. 4A shows an embodiment of a composite sensing fiber 155 that may be used in the embodiment of FIG. 3. The composite sensing fiber 155 may include two or more fiber cores, anyone of which may be a single-mode fiber core (SMF), a multimode fiber core (MMF), or a multi-core fiber core (MCF). The composite optical sensing fiber 155 includes a sensing fiber core 153 and a delivery fiber core 116. The sensing fiber core 153 operates like the sensing optical fiber 152 described above. The delivery fiber core 116 operates like the delivery optical fiber 115 described above. Reflector 146 is shown in an expanded view in FIG. 4B and is described further below. Any longitudinal segment of the composite optical sensing fiber 155 may be considered as a sensing region 130.

The cross-section of any part of the composite optical sensing fiber 155 may be of any shape. A circular cross-section is shown in FIG. 4A. The composite optical sensing fiber 155 may include two or more fiber cores (two are shown). Each fiber core may have a circular shape (as shown) or may be a core of another shape, such as an elliptical core or an oval core. In the shown example the composite optical sensing fiber 155, has a delivery fiber core 116 and sensing fiber core 153. Delivery fiber core 116 may provide functions similar to those provided by delivery optical fiber 115 described above. The sensing fiber core 153 may provide functions similar to those provided by sensing optical fiber 152 described above.

FIG. 4B shows an example optical reflector 146 that may be used in the example implementation shown in FIG. 3. Optical reflector 146 may include an optical coupler 148 in addition to that included in reflector 140. The optical coupler 148 optically couples the delivery fiber core 116 of the composite optical sensing fiber 155 to the optical coupling fiber 147. The coupling fiber 147 is further optically coupled to the optical splitter and optical delays 142 as described above. The optical splitter and delays 142 are then optically connected to the MCFD 144 as described above. The MCFD 144 optically couples light signals into various modes of a multimode optical coupling fiber 156 that is optically then connected to the optical coupler 148. The optical coupler 148 optically couples the light signals from the multimode optical coupling fiber 156 to the sensing fiber core 153 of the composite optical fiber 155.

In another embodiment, optical backscattering may be used to measure parameters in the optical sensing fiber. This may be combined with the use of optical forward scattering as described above. If measurement of the optical backscattering is also desired in conjunction with optical forward scattering as described in FIG. 1, then an optical coupler may be added to the delivery fiber 115 near the light source to couple the optically backscattered signals to a receiver to process the optical backscattered signals to provide additional measurements. Further, if optical backscattering measurements are also to be made, then if the delivery fiber 115 is a multimode fiber, then the same processing of the various modes as described above may be performed to utilize localized mode coupling features, i.e., related to environmental fluctuations, to make measurements.

Optical backscattering measurements may also be used in the embodiment of FIG. 3. The optical receivers 180-184 may also seek to detect and process backscattered light signals from the sensing core 153. This would typically require the receivers 180-184 to have the sensitivity and dynamic range to process both the backscattered light signals and the forward scattered light signal. Also, the optical receivers 180-184 would look for backscattered optical signals earlier in the receive window as the backscattered signals would arrive earlier than the forward scattered signals. During this earlier window, the optical receivers 180-184 could use automatic gain control (AGC) to compensate for the different signal levels.

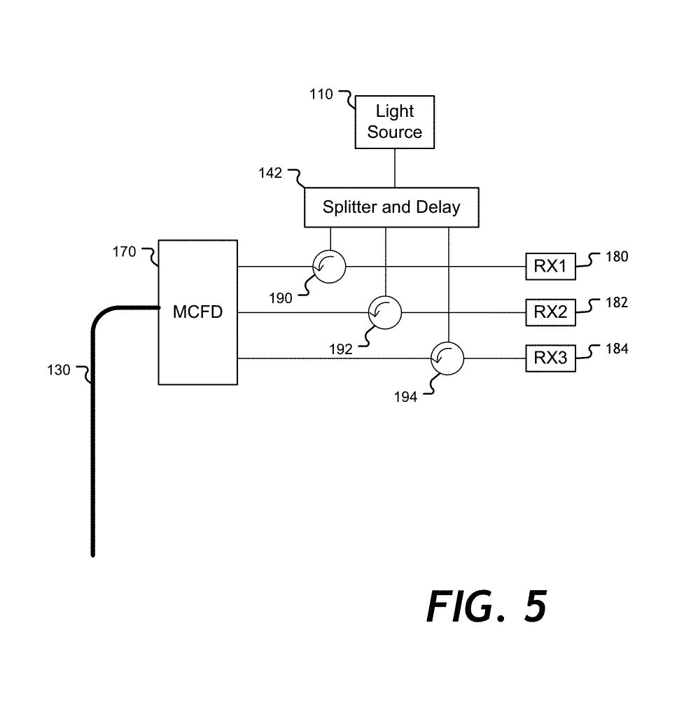

FIG. 5 illustrates another embodiment of the of a multimode optical fiber sensor using only light backscattering. The multimode optical fiber sensor includes a light source 110, an optical splitter and delay 142, optical circulators 190-194, optical receivers 180-184, MCFD 170, and optical sensing fiber 130. The various elements with the same numbers as used above function in the same manner as described above. The light source 110 produces a light signal that is split and delayed in element 142 (if multiple input modes are to be used). The outputs of the optical splitter and delay 142 are coupled to the optical circulators 190-194. The optical circulators 190-194 optically couple the input light signals to the MCFD 170. The MCFD 170 then optically couples the various light signals into the different propagation modes of the optical sensing fiber 130. As the light signals encounter various sensing features in the optical sensing fiber 130, the light is backscattered back up the optical sensing fiber 130 to the MCFD 170. The MCFD 170 separates the backscattered light signals from the optical sensing fiber 130 and optically couples them back to the optical circulators 130. The optical circulators 190-194 then couple the backscattered light signals to the optical receivers 180-184. The optical receivers 180-184 then process the received light signals as described above to make measurements of localized environmental fluctuations and to determine the locations of those fluctuations.

Any component shown in the embodiments described herein may be a physical component or a logical component, which may be made up of a number of physical parts.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. An apparatus, comprising:
an optical sensor fiber having a first end optically couplable to receive light from a light source, wherein the optical sensor fiber is a multimode optical fiber configured to carry light in different spatial propagating modes, wherein the optical sensor fiber is constructed such that environmental fluctuations couple light energy between some of the spatial propagating modes;
a spatial propagating mode demultiplexer optically coupled to a second end the optical sensor fiber and configured to separate a plurality of light signals received from different ones of the spatial propagating modes; and
an optical receiver configured to process the separated light signals and to estimate a longitudinal position of one of the environmental fluctuations along the optical sensor fiber based a measured delay between arrival times of the separated light signals.

2. The apparatus of claim 1, further comprising an optical splitter configured to split a light signal from the light source into a plurality of light signals and optically couple said light signals to different ones of the spatial propagating modes at the first end.

3. The apparatus of claim 2, further comprising an optical delivery fiber core configured to couple the light signal from the light source to the optical splitter, the optical delivery fiber being near to and substantially parallel to an optical core of the optical sensor fiber.

4. The apparatus of claim 2, further comprising a second spatial propagating mode demultiplexer configured to couple the optical splitter to the optical sensor fiber.

5. The apparatus of claim 2, further wherein optical splitter is configured to relatively delay the split light signals from one another.

6. The apparatus of claim 2, wherein the optical receivers calculate another characteristic of the one of the environmental fluctuations based upon a measurement of a spatial propagating mode coupling of the optical sensor fiber.

7. The apparatus of claim 2, wherein the position is calculated based upon the difference in group velocities of some of the spatial propagating modes of the optical sensor fiber.

8. The apparatus of claim 7, wherein a difference in group velocities of some of the spatial propagating modes of the optical sensor fiber are large enough to temporally separate some of the light signals received from different ones of the spatial propagating modes at the second end.

9. The apparatus of claim 1, further comprising an optical coupler coupled between the light source and the sensor fiber and between the sensor fiber and the spatial propagating mode demultiplexer, wherein the optical sensor fiber is a composite optical sensor fiber including a multimode fiber sensing core and a delivery fiber core and the optical coupler is configured to optically couple light from the light source into the delivery fiber core and to couple light from the sensor fiber core to the a spatial propagating mode demultiplexer.

10. A method, comprising:
coupling a light signal from a light source into a first end of optical sensor fiber, wherein the optical sensor fiber is a multimode fiber configured to carry light in different spatial propagating modes and wherein the optical sensor fiber is constructed such that nearby environmental fluctuations can couple light energy between some of the spatial propagating modes;
in an optical spatial propagating mode demultiplexer, separating light signals from different ones of the spatial propagating modes of the optical sensor fiber at a second end the optical sensor fiber; and
processing the separated light signals in optical receivers to determine a position of one of the environmental fluctuations along the optical sensor fiber based measurements of relative delays between the light signals.

11. The method of claim 10, further comprising:
with an optical splitter, splitting a light signal from a light source into a plurality of light signals; and
coupling the light signals from the light source into different ones of the spatial propagating modes at the first end of the optical sensor fiber.

12. The method of claim 11, further comprising coupling the light signal from the light source to the optical splitter by a delivery fiber core, wherein the delivery fiber core is substantially alongside the optical sensor fiber.

13. The method of claim 11, further comprising optically coupling the optical splitter to the optical sensor fiber by an optical spatial propagating mode demultiplexer.

14. The method of claim 11, further comprising delaying the split light signals from one another by the optical splitter.

15. The method of claim 11, wherein the optical receivers is configured evaluate another characteristic of the one of the environmental fluctuations based upon a spatial propagating mode coupling in the sensor fiber.

16. The method of claim 11, wherein the position is calculated based upon the difference in group velocities of some of the spatial propagating modes.

17. The method of claim 16, wherein the difference in group velocities are large enough to separate, at the second end, the light signals received from the different modes in time.
